(19) United States
(12) Patent Application Publication
(10) Pub. No.: US 2014/0138194 A1
(43) Pub. Date: May 22, 2014

(54) BRAKING SYSTEMS WITH COOLING

(71) Applicant: William Edward FENNA, Bath (GB)

(72) Inventor: William Edward FENNA, Bath (GB)

(21) Appl. No.: 14/078,000

(22) Filed: Nov. 12, 2013

Related U.S. Application Data
(62) Division of application No. 12/278,371, filed on Nov. 11, 2008.

(51) Int. Cl. F16D 65/847; F16D 65/853

(52) U.S. Cl. CPC F16D 65/847; F16D 65/853
USPC 188/264 A; 188/264 D

(57) ABSTRACT

A braking system includes an axle, a support element mounted on the axle, a brake ring connected to the periphery of the support element and a brake calliper for applying a braking force to the brake ring. The brake ring is connected to the support element in such a manner that a conductive heat flow path is provided for conducting heat from the brake ring into the support element. There is also an airflow path passing through the support element and through the region in which the brake calliper is situated for transferring heat by convection from the brake ring and the brake calliper.

This application is a Divisional Application of U.S. application Ser. No. 12/278,371 filed 11 Nov. 2008, which is a U.S. National Stage Application of PCT/GB2006/000415, filed Feb. 7, 2006, and which applications are incorporated herein by reference. A claim of priority to all, to the extent appropriate is made.

This invention relates to braking systems particularly, but not exclusively, for vehicle wheels.

Braking systems for vehicle wheels generally function by converting kinetic energy into heat energy using a braking system which includes a surface with a high coefficient of friction to slow down the wheels. The problem is that if the generated heat is not dissipated, the braking efficiency of the systems becomes less and less, and eventually the brakes fail through so-called brake fade.

Drum brakes are particularly vulnerable to brake fade because more of the drum is heated by the friction generating shoes than is available to dissipate heat by convection to the surrounding air.

Disc brakes are generally more efficient than drum brakes because they enable greater pressure to be applied by a calliper squeezing brake pads on to a brake disc attached to the associated wheel hub than can be applied to the internal surface of the drum of a drum brake. The area of heating contact between the friction pads of disc brakes and their associated discs can therefore be substantially reduced compared with that of brake shoes with their associated drums for the same braking effort. Typically, 20% of the surfaces of the discs of disc brakes are intensely heated by disc pads, with 80% of the disc being available to dissipate heat by convection to the surrounding air within the confines of the associated wheel.

In an attempt to improve their vehicle braking systems, manufacturers have been increasing the internal diameters of the wheels of their vehicles so that larger diameter discs and larger brake callipers can be fitted. This can enable the braking leverage of braking systems to be increased as a result of the increased disc radius. However, the larger radius of these larger discs means that the associated calliper has to be considerably longer than with the conventional smaller discs to cover the depth of the discs.

The longer so-called “beam” callipers used with these larger discs are generally of four or six pot construction, and this adds considerably to their complexity and cost of production. In addition, they greatly reduce the area of the brake disc which is exposed for cooling by convection to air inside the wheel, and they can also worsen the “plug” effect by reducing the air space available to cool the discs by convection of air inside the associated wheel.

The main inherent problem with both drum and disc braking systems is, therefore, that heat dissipation from them by convection through the air alone is generally insufficient to prevent brake fade. Furthermore, the very designs of the braking systems themselves tend to reduce their efficiency by disrupting airflow over surfaces which should serve to cool these surfaces.

It is an object of the invention to provide a braking system which can be cooled particularly well and exhibit high and prolonged performance.

According to the invention there is provided a braking system comprising an axle, a support element mounted on the axle, a brake ring connected to the periphery of the' support element and a brake calliper for applying a braking force to the brake ring, the brake ring being connected to the support element in such a manner that a conductive heat flow path is provided for conducting heat from the brake ring into the support element and there being an airflow path passing through the support element and through the region in which the brake calliper is situated for transferring heat by convection from the brake ring and the brake calliper.

By cooling the braking arrangement both by conduction of heat from the ring into the support element and by convection cooling of the support element, the ring and the brake calliper, it becomes possible to provide a braking system with good cooling and high performance, even with prolonged braking.

The braking system may be applied to a wheel of a vehicle, for example a car. The wheel may include a hub and the support element. The support element may extend from the hub to the brake ring. The brake ring may form part of, or be connected to, the rim of the wheel.

Whilst it is within the scope of the invention to rely on cooling air currents being generated by convection or other factors, the braking system preferably includes air current generating means for creating a flow of air along the airflow path. For example, vanes may be provided for creating the flow of air along the airflow path. The vanes may form part of the support element. In one embodiment of the invention the vanes may be provided in the hub of the wheel. In another embodiment of the invention the vanes may be provided in an element, which may be the support element, extending outwardly from an axle.

In order to provide an effective airflow path passing through the support element, the support element preferably has openings occupying a large proportion of its cross-sectional area. Preferably, at least 20%, and more preferably at least 40%, of the cross-sectional area of the support element comprises one or more openings to allow airflow through the support element.

The brake ring may be detachably connected to the support element or it may be integral with the support element. In either case, there should be a good conductive path for conducting heat from the brake ring into the support element. Accordingly, the interface of the brake ring and the support element preferably comprises a continuous annular interface. The interface preferably has a cross-sectional area that is at least 20% and preferably more than 50% of the cross-sectional area of the brake ring immediately upstream of the interface. Thus heat flowing to the interface from the brake ring suffers not more than a 50% reduction in the cross-sectional area available for the conduction of heat.

Preferably the brake ring projects radially inwardly from the periphery of the support element. In that case the brake calliper is situated to the inside of the brake ring, enabling the brake ring to be of a greater diameter. Preferably, the brake ring is planar and is in a plane perpendicular to the axis of rotation.

As well as cooling by ordinary air convection, it is within the scope of the invention to provide an enclosed region around a part of the brake ring and/or the brake calliper and to feed fluid into the region and remove fluid from the region. Such an arrangement can enable more efficient heat exchange into the fluid, which may be a refrigerant and may be recirculated.

In the aspect of the invention defined above, a preferred form of braking system is defined. It is however possible to provide a braking system in accordance with the invention that comprises a different selection of the features defined above. According to a broad aspect of the invention, there is provided a braking system comprising an axle, a support element mounted on the axle, a brake ring connected to the periphery of the support element and a brake calliper for applying a braking force to the brake ring, the system further including one or more of the following features:
(i) the brake ring is connected to the support element in such a manner that a conductive heat flow path is provided for conducting heat from the brake ring into the support element;
(ii) there is an airflow path passing through the support element and through the region in which the brake calliper is situated for transferring heat by convection from the brake ring and the brake calliper;
(iii) the support element is part of a wheel;
(iv) the braking system includes air current generating means for creating a flow of air along the airflow path;
(v) the brake ring is integral with the support element;
(vi) the brake ring is planar and is in a plane perpendicular to the axis of rotation of the axle;
(vii) the braking system includes a refrigerant system for cooling the braking system.

The braking system according to the broad aspect of the invention may further incorporate any of the other features defined above.

The braking system may be used in a wide variety of applications including, but not limited to, various vehicles. Examples of the invention including cars, including racing cars, trains and aircraft are described below.

By way of example, embodiments of the invention will now be described with reference to the accompanying schematic drawings, in which:

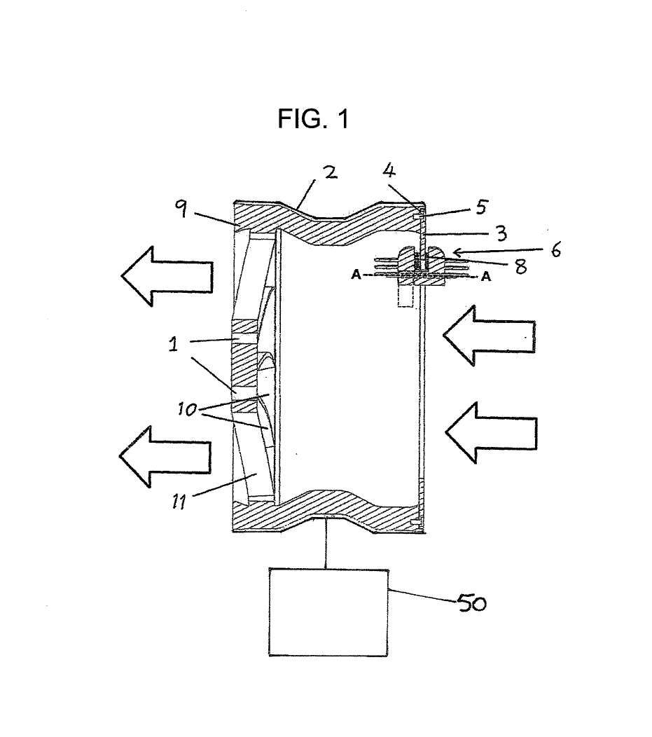

FIG. 1 is a vertical section through a braking system applied to a conventional car wheel;

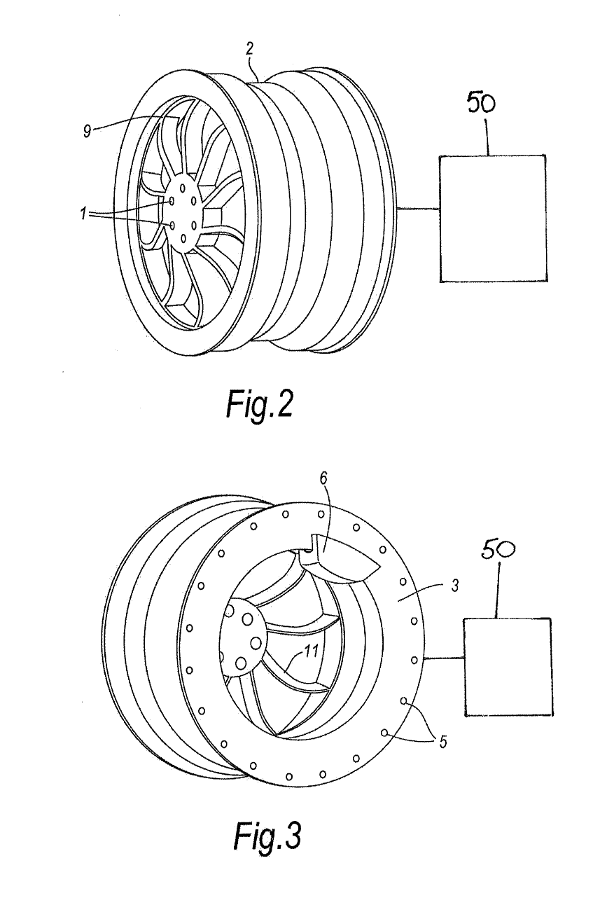

FIG. 2 is a perspective view from the outside of a vehicle wheel that is a modified form of the wheel of FIG. 1;

FIG. 3 is a perspective view from the inside of the wheel of FIG. 2 with a brake ring attached to the wheel;

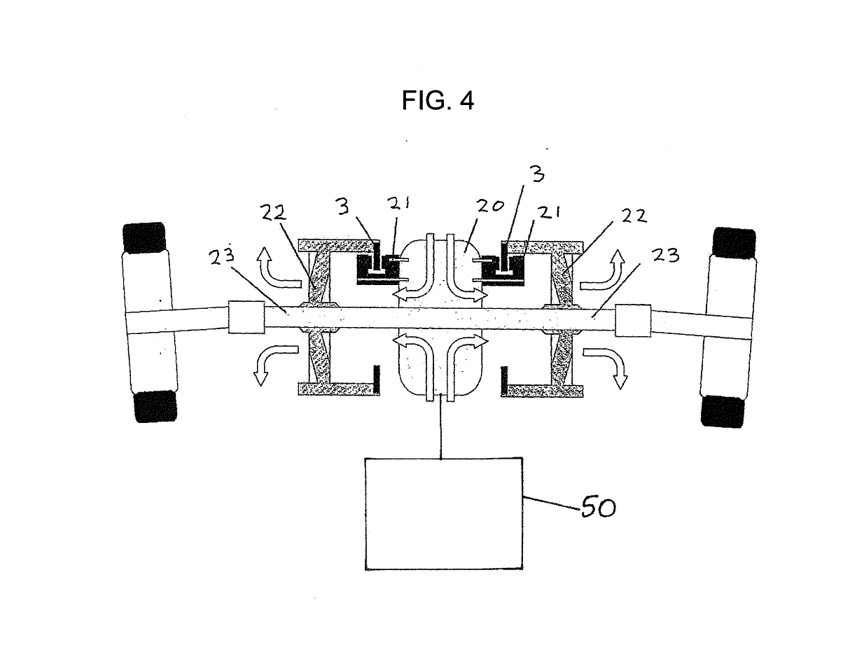

FIG. 4 is a sectional view of a car wheel axle assembly with a modified form of braking system;

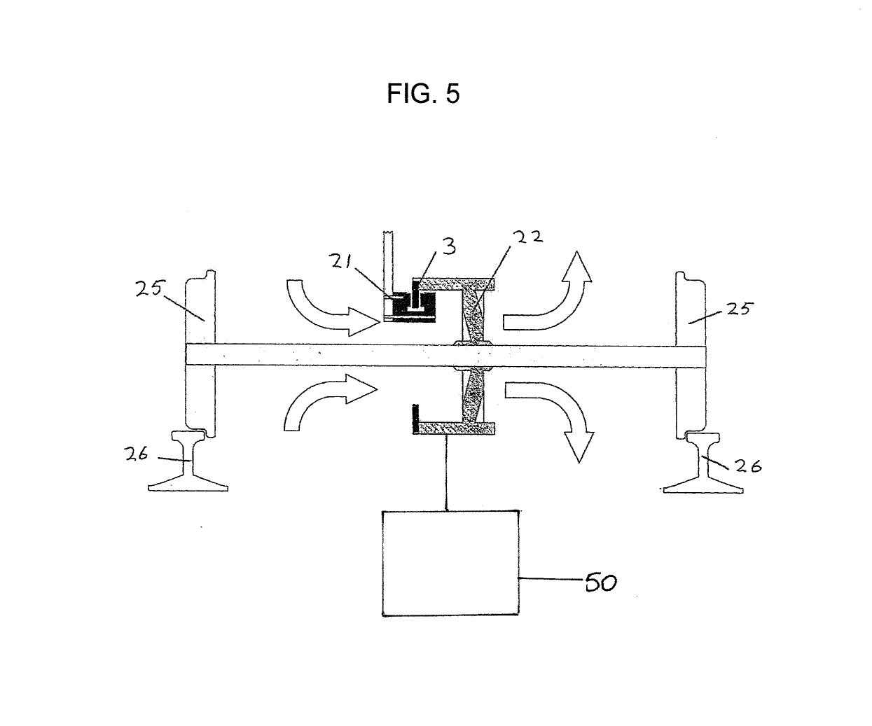

FIG. 5 is a perspective view of a train axle with a braking system; and

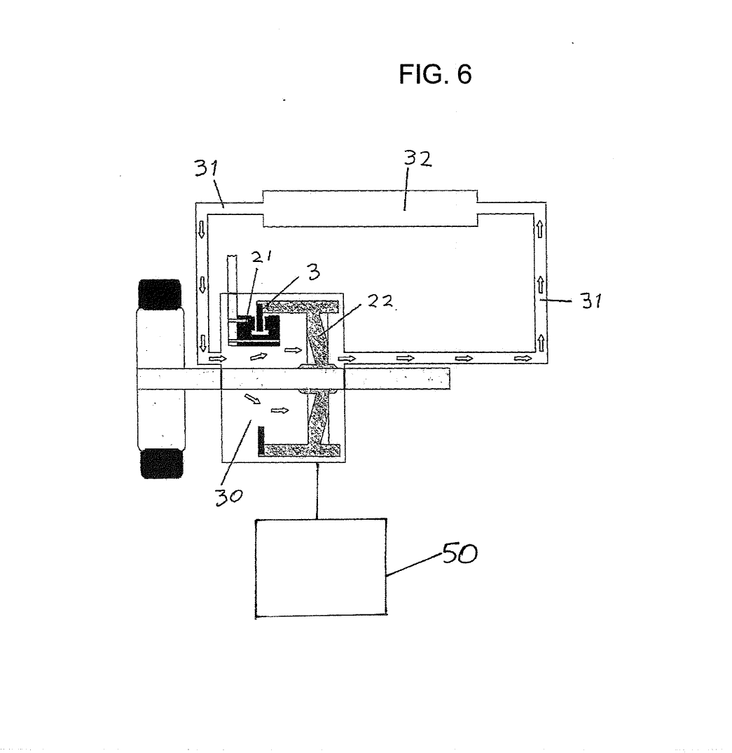

FIG. 6 is a schematic perspective view of a braking system for a vehicle wheel, including a refrigerant system.

The car vehicle wheel shown in FIG. 1 is generally conventional in that it has fixing holes 1 for securing it to an axle of the vehicle and a support element 9 including a rim 2 for receiving a pneumatic tyre (not shown). However, it differs from conventional vehicle wheels in that it includes an annular brake ring 3 which is secured in an annular recess 4 in the rim 2 by countersunk bolts 5. Also the support element 9 that extends from the central part of the wheel to the rim 2 is provided with many openings 10.

Braking forces can be applied to the brake ring 3 using a calliper 6 which is attached to the vehicle suspension and can be operated hydraulically in conventional manner via an hydraulic hose (not shown) to force hydraulic pistons against brake pads 8, and the latter into frictional engagement with the ring 3.

In use air currents pass over the brake calliper 6 and the brake ring 3 and through the openings 10 taking heat generated during braking away from those parts. Also, heat generated in the brake ring 3 flows through the interface with the rim 2 into the rim part of the support element 9. The connection of the brake ring 3 to the rim 2 is the same around all the periphery of the wheel with the bolts 5 provided at intervals. Thus a conductive heat flow path is provided for the ring 3 into the support element 9.

In the particular example shown, the cross-sectional area of the interface of the brake ring and the support element 9 is as great as the cross-sectional area of the brake ring immediately upstream of the interface. Thus provided the ring 3 and support element 9 are made of thermally conductive material and there is good thermal contact at the interface, a good conductive heat flow path is formed for conducting heat from the brake ring 3 into the support element 9. In the embodiment shown in FIG. 1 the openings 10 account for about 90% of the cross-sectional area of the support element 9 and there is therefore an airflow path through the support element 9 and through the region in which the brake calliper 6 is situated. Consequently transfer of heat from the brake ring 3 and the brake calliper 6 by convection is facilitated. If desired, the convection can be further enhanced by making it forced convection, for example by providing vanes on the support element to drive airflow through the openings 10. This is the case in the embodiment of FIG. 1 where the support element 9 includes vanes 11.

Removal and replacement of the wheel from the vehicle can be effected in substantially conventional manner by first releasing and then rotating a portion of the calliper 6 about the line A-A so that it can be moved to the position indicated by broken lines in the drawing, and then removing and subsequently replacing the fixing nuts or bolts which hold the wheel on the vehicle axle.

Vehicle braking systems in accordance with the present invention can be used on a variety of vehicles. They can be used on road vehicles, for example cars, buses, lorries and road vehicle trailers, and they can be used on vehicles which run on rails or tracks, for example railway carriages, railway wagons and trams, and they can be used on aircraft.

FIG. 2 shows a modified form of wheel generally similar to that of FIG. 1 with the same reference numerals designating corresponding parts. In FIG. 2 the brake ring 3 and the brake calliper 6 are not shown. Those parts are shown in FIG. 3. Also in FIGS. 2 and 3 the support element 9 is shown having vanes 11 generating a flow of air through the wheel (as indicated by the arrows in FIG. 1).

In the embodiment shown in FIGS. 2 and 3, both the support element 9 and the brake ring 3 are made of aluminium, a thermally conductive material.

An advantage of providing the brake ring 3 is that it adds strength to the inner rim of the wheel allowing the thickness of parts of the wheel to be reduced.

Especially in high performance cars, it may be desirable to monitor the temperature of the brake ring and/or the brake pads, for example with a laser thermometer (not shown) and use that temperature signal as an input to a controller controlling the braking.

FIG. 4 shows a modified arrangement of a car in which the braking system is mounted on rear axles 23 of a vehicle away from the wheels. In the example shown the systems are mounted on either side of a differential or gearbox unit 20 on which the brake callipers 21 for each of the systems are mounted. Each braking system comprises a support element 22 which is an open vaned element, which is mounted on a respective axle 23 and which extends outwardly and is connected at its periphery to a brake ring 3 on which the callipers 21 act. The vaned support element 22 serves both to generate an airflow in the region of the brake ring 3 and the callipers 21 and also, as a result of its fin-like structure, cools the support element. Arrows show the direction of airflow.

FIG. 5 shows an arrangement similar to that of FIG. 4 but applied to an axle of a railway vehicle having wheels 25 on rails 26. The same reference numerals are used in FIG. 5 as in FIG. 4 to designate corresponding parts.

FIG. 6 shows schematically a braking system of the kind shown in FIGS. 4 and 5 with a fluid cooling system. A sealed chamber 30 is provided in the region of the braking system and refrigerant circulated along tubes 31 between the chamber 30 and another heat exchanging radiator 32 where the refrigerant condenses and cools. It should be understood that FIG. 6 is schematic and the chamber 30 may for example only surround the calliper and be in sealing contact with the brake ring 3.

1. A braking system comprising an axle, a support element mounted on the axle, a brake ring connected to the periphery of the support element and a brake calliper for applying a braking force to the brake ring, the brake ring being connected to the support element in such a manner that a conductive heat flow path is provided for conducting heat from the brake ring into the support element and there being an airflow path passing through the support element and through the region in which the brake calliper is situated for transferring heat by convection from the brake ring and the brake calliper.

2. A braking system according to claim 1, wherein the support element is part of a wheel.

3. A braking system according to claim 1, further including air current generating means for creating a flow of air along the airflow path.

4. A braking system according to claim 3, wherein the support element includes vanes for creating the flow of air along the airflow path.

5. A braking system according to claim 1 wherein the brake ring is detachably connected to the support element.

6. A braking system according to claim 1, wherein the brake ring is integral with the support element.

7. A braking system according to claim 1, wherein the brake ring projects radially inwardly from the periphery of the support element.

8. A braking system according to claim 7, wherein the brake ring is planar and is in a plane perpendicular to the axis of rotation of the axle.

9. A braking system comprising an axle, a support element mounted on the axle, a brake ring connected to the periphery of the support element and a brake calliper for applying a braking force to the brake ring, the system further including one or more of the following features:
(i) the brake ring is connected to the support element in such a manner that a conductive heat flow path is provided for conducting heat from the brake ring into the support element;
(ii) there is an airflow path passing through the support element and through the region in which the brake calliper is situated for transferring heat by convection from the brake ring and the brake calliper;
iii) the support element is part of a wheel;
(iv) the braking system includes air current generating means for creating a flow of air along the airflow path;
(v) the brake ring is integral with the support element;
(vi) the brake ring is planar and is in a plane perpendicular to the axis of rotation of the axle;
(vii) the braking system circulates a refrigerant system for cooling the braking system.

10. A braking system according to claim 1, further including a refrigerant system for cooling the braking system.

11. A vehicle including a braking system according to claim 1.

12. A vehicle according to claim 11, wherein the vehicle is a car.

13. A vehicle according to claim 11, wherein the vehicle is a train.

14. A vehicle according to claim 11, wherein the vehicle is an aircraft.

15. A braking system according to claim 1 comprising a wheel mounted on the axle, the support element being spaced from the wheel.

16. A braking system according to claim 1 wherein the caliper is located to the inside of the brake ring.

17. A braking system comprising an axle and a wheel mounted on the axle, the braking system further comprising a support element mounted on the axle and extending outwardly therefrom to a periphery, a brake ring being supported by the support element and being connected to the periphery of the support element and a brake calliper for applying a braking force to the brake ring, the brake ring being connected to the support element in such a manner that a conductive heat flow path is provided for conducting heat from the brake ring into the support element and there being an airflow path passing through the support element and through the region in which the brake calliper is situated for transferring heat by convection from the brake ring and the brake calliper.

18. A braking system according to claim 17, further including air current generating means for creating a flow of air along the airflow path.

19. A braking system according to claim 18, in which the support element comprises vanes for creating a flow of air through openings between vanes and over the brake ring and brake caliper for transferring heat by convection from the support element, the brake ring and the brake caliper.

20. A braking system according to claim 17 comprising a wheel mounted on the axle, the support element being spaced from the wheel.
